(19) United States
(12) Patent Application Publication
(10) Pub. No.: US 2025/0046059 A1
(43) Pub. Date: Feb. 6, 2025

(54) OBJECT RECOGNITION DEVICE, OBJECT RECOGNITION METHOD, AND RECORDING MEDIUM

(71) Applicant: NEC Corporation, Minato-ku, Tokyo (JP)

(72) Inventor: Soma Shiraishi, Tokyo (JP)

(73) Assignee: NEC Corporation, Minato-ku, Tokyo (JP)

(21) Appl. No.: 18/719,943

(22) PCT Filed: Dec. 28, 2021
(86) PCT No.: PCT/JP2021/048764

§ 371 Date: Jun. 14, 2024

(51) Int. Cl. G06V 10/764; G06V 10/74; G06V 20/68

(52) U.S. Cl. CPC G06V 10/764; G06V 10/761; G06V 20/68

(57) ABSTRACT

In the object recognition device, an image acquisition means acquires an image including a plurality of objects. An object recognition means acquires recognition results corresponding to each of the plurality of objects included in the image. A connection relationship specifying means performs processing for specifying whether or not there is a connection relationship of a plurality of object areas. An area relationship acquisition means acquires an area relationship information. A class relationship acquisition means acquires a class relationship information. A recognition result correction means acquires a plurality of corrected recognition results by performing processing for correcting the recognition results based on the area relationship information and the class relationship information. An evaluation means acquires a final recognition result relating to the class to which each of the plurality of objects belongs, by evaluating the recognition results using the plurality of the corrected recognition result.

### TECHNICAL FIELD

The present disclosure relates to recognition of objects contained in an image.

### BACKGROUND ART

A method of managing shelving of products using an image of capturing a product shelf in a store has been proposed.

Specifically, for example, Patent Document 1 discloses a viewpoint of determining the adequacy of recognizing a product represented by one product area image as a first product in an image obtained by capturing a product shelf in which a plurality of products are arranged, and recognizing the product represented by another product area image other than the first product area image as a second product, and further recognizing the adequacy of recognizing the first product area image as the first product based on the relevance between the first product and the second product.

### PRECEDING TECHNICAL REFERENCES

### Patent Document

Patent Document 1: International Publication WO2019/107157

### SUMMARY

### Problem to be Solved by the Invention

However, according to the viewpoint disclosed in Patent Document 1, there may occur such a program that, since the validity of the recognition result is determined based on the relevance between products in a plurality of products, the recognition accuracy of individual products in the plurality of products may be lowered.

One object of the present disclosure is to provide an object recognition device capable of improving recognition accuracy of individual objects in a plurality of objects included in an image.

### Means for Solving the Problem

According to one aspect of the present disclosure, there is provided an object recognition device comprising:
an image acquisition means configured to acquire an image including a plurality of objects;
an object recognition means configured to acquire recognition results corresponding to each of the plurality of objects included in the image by performing object recognition processing on the image;
a connection relationship specifying means configured to perform processing for specifying whether or not there is a connection relationship of a plurality of object areas corresponding to the plurality of objects based on the recognition results obtained by the object recognition processing;
an area relationship acquisition means configured to acquire area relationship information that is information related to a relationship of each object areas identified to have the connection relationship;
a class relationship acquisition means configured to acquire class relationship information that is information indicating a relationship of a plurality of classes set in advance in order to obtain the recognition results by the object recognition processing;
a recognition result correction means configured to acquire a plurality of corrected recognition results by performing recognition result correction processing for correcting the recognition results obtained by the object recognition processing based on the area relationship information and the class relationship information; and
an evaluation means configured to acquire a final recognition result relating to the class to which each of the plurality of objects belongs, by evaluating the recognition results obtained by the object recognition processing using the plurality of the corrected recognition result.

According to another aspect of the present disclosure, there is provided an object recognition method comprising:
acquiring an image including a plurality of objects;
acquiring recognition results corresponding to each of the plurality of objects included in the image by performing object recognition processing on the image;
performing processing for specifying whether or not there is a connection relationship of a plurality of object areas corresponding to the plurality of objects based on the recognition results obtained by the object recognition processing;
acquiring an area relationship information that is information related to a relationship of each object areas identified to have the connection relationship;
acquiring a class relationship information which is information indicating a relationship of a plurality of classes set in advance in order to obtain the recognition results by the object recognition processing;
acquiring a plurality of corrected recognition results by performing recognition result correction processing for correcting the recognition results obtained by the object recognition processing based on the area relationship information and the class relationship information; and
acquiring a final recognition result relating to the class to which each of the plurality of objects belongs, by evaluating the recognition results obtained by the object recognition processing using the plurality of the corrected recognition result.

According to still another aspect of the present disclosure, there is provided a recording medium for recording a program, the program causing a computer to execute:
acquiring an image including a plurality of objects;
acquiring recognition results corresponding to each of the plurality of objects included in the image by performing object recognition processing on the image;
performing processing for specifying whether or not there is a connection relationship of a plurality of object areas corresponding to the plurality of objects based on the recognition results obtained by the object recognition processing;
acquiring an area relationship information that is information related to a relationship of each object areas identified to have the connection relationship;
acquiring a class relationship information which is information indicating a relationship of a plurality of classes set in advance in order to obtain the recognition results by the object recognition processing;
acquiring a plurality of corrected recognition results by performing recognition result correction processing for correcting the recognition results obtained by the object recognition processing based on the area relationship information and the class relationship information; and
acquiring a final recognition result relating to the class to which each of the plurality of objects belongs, by evaluating the recognition results obtained by the object recognition processing using the plurality of the corrected recognition result.

### Effect

According to the present disclosure, it is possible to provide an object recognition device capable of improving the recognition accuracy of individual objects in a plurality of objects included in an image.

### BRIEF DESCRIPTION OF THE DRAWINGS

FIG. 1 A diagram showing an outline of an object recognition device according to a first example embodiment.

FIG. 2 A block diagram showing a hardware configuration of an object recognition device according to the first example embodiment.

FIG. 3 A block diagram showing a functional configuration of an object recognition device according to the first example embodiment.

FIG. 4 A diagram illustrating an example of an image used in processing of the object recognition device according to the first example embodiment.

FIG. 5 A diagram for explaining a product area and an empty area detected by the processing of the object recognition device according to the first example embodiment.

FIG. 6A A diagram for explaining processing of specifying a connection relationship performed in the object recognition device according to the first example embodiment.

FIG. 6B A diagram for explaining processing of specifying a connection relationship performed in the object recognition device according to the first example embodiment.

FIG. 6C A diagram for explaining processing of specifying a connection relationship performed in the object recognition device according to the first example embodiment.

FIG. 7 A diagram illustrating an example of attribute information used in acquiring class relationship information.

FIG. 8 A diagram for explaining an example of information that may be included as the class relationship information.

FIG. 9 A diagram for explaining an example of information that may be included as the class relationship information.

FIG. 10 A flowchart for explaining processing performed in the object recognition device according to the first example embodiment.

FIG. 11 A block diagram showing a functional configuration of an object recognition device according to a second example embodiment.

FIG. 12 A flowchart for explaining processing performed in the object recognition device according to the second example embodiment.

### EXAMPLE EMBODIMENTS

Preferred example embodiments of the present disclosure will be described with reference to the accompanying drawings. In this specification, a character to which a symbol “˜” is attached at its top is expressed as “A^{˜}” (where “A” is any character) for convenience.

### First Example Embodiment

### [Schematic Configuration]

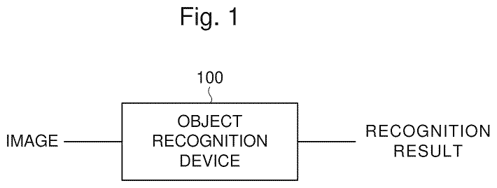

FIG. 1 is a diagram showing an outline of an object recognition device according to a first example embodiment. The object recognition device 100 is configured as a portable terminal device such as a tablet terminal, for example. The object recognition device 100 recognizes the individual products displayed on the product shelf from the image obtained by capturing the product shelf of the store. The object recognition device 100 acquires the processing result obtained by performing processing such as correction on the recognition results of the individual products as the final recognition result.

### [Hardware Configuration]

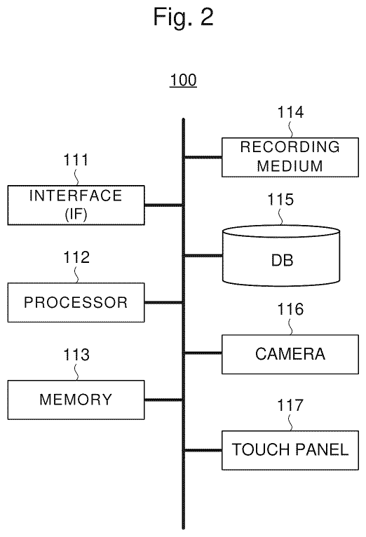

FIG. 2 is a block diagram showing a hardware configuration of an object recognition device according to the first example embodiment. The object recognition device 100 includes, as shown in FIG. 2, an interface (IF) 111, a processor 112, a memory 113, a recording medium 114, and a data base (DB) 115, a camera 116, and a touch panel 117.

The IF 111 inputs and outputs data to and from external devices. The final recognition result obtained by the object recognition device 100 is outputted to the external device through the IF 111 as required.

The processor 112 is a computer such as a CPU (Central Processing Unit) and controls the entire object recognition device 100 by executing a program prepared in advance. Specifically, the processor 112 performs processing such as object recognition processing and recognition result correction processing.

The memory 113 may be configured by a ROM (Read Only Memory), a RAM (Random Access Memory), and the like. The memory 113 is also used as a working memory during various processing operations by the processor 112.

The recording medium 114 is a non-volatile and non-transitory recording medium such as a disk-like recording medium or a semiconductor memory and is detachably configured to the object recognition device 100. The recording medium 114 records various programs executed by the processor 112. When the object recognition device 100 performs various processing, the program recorded on the recording medium 114 is loaded into the memory 113 and executed by the processor 112.

The DB 115 stores, for example, data inputted through the IF 111, processing results obtained by processing of the processor 112, and images obtained by the camera 116.

The camera 116 obtains an image by capturing a product shelf on which a plurality of products is displayed. In the present example embodiment, as long as a plurality of products is disposed at a position of substantially equal distance from the camera 116, the plurality of products may be disposed in a furniture or the like other than the product shelf. Further, in the present example embodiment, as the camera 116, for example, a depth camera capable of acquiring both the image and the depth information at the time of capturing may be provided in the object recognition device 100. When the depth camera is provided in the object recognition device 100, for example, appropriate information can be acquired as size information SZJ to be described later, even when a plurality of products is not disposed at a position of substantially equal distance from the camera 116.

The touch panel 117 has a function capable of displaying, for example, an image captured by the camera 116 and a final recognition result obtained through processing by the processor 112. In addition, the touch panel 117 has, for example, a function capable of inputting an instruction, information, or the like corresponding to the touch operation of the user.

### [Function Configuration]

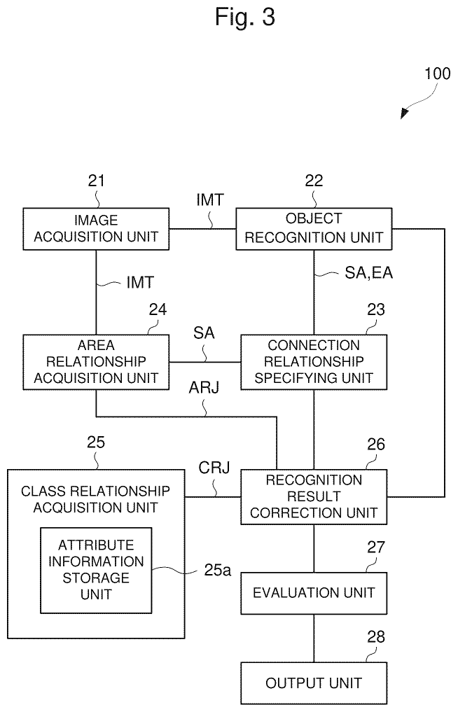

FIG. 3 is a block diagram showing a functional configuration of the object recognition device according to the first example embodiment. As shown in FIG. 3, the object recognition device 100 includes an image acquisition unit 21, an object recognition unit 22, a connection relationship specifying unit 23, an area relationship acquisition unit 24, a class relationship acquisition unit 25, a recognition result correction unit 26, an evaluation unit 27, and an output unit 28.

The image acquisition unit 21 acquires an image IMT by capturing the product shelf in which a plurality of products is displayed. The image acquisition unit 21 is not limited to acquiring the image IMT by capturing the product shelf, but may also acquire the images IMT from, for example, a database in which a set of images obtained by capturing product shelves is stored in advance.

The object recognition unit 22 acquires the recognition result corresponding to each of the plurality of products included in the image IMT by performing object recognition processing on the image IMT using a learned object recognition model configured by a neural network or the like, for example.

Specifically, the object recognition unit 22 detects a rectangular area corresponding to each of the plurality of products included in the image IMT as a plurality of product area SA, and detects an area in which no product exists within a certain range in the image IMT as the empty area EA. The object recognition unit 22 acquires a recognition score that is a value indicating the probability of each class when each product included in the plurality of product area SA is classified into any one of a plurality of preset classes on the basis of the extraction result obtained by extracting the position, size, and feature quantity of the plurality of product areas SA.

Based on the plurality of product areas SA detected by the object recognition unit 22, the connection relationship specifying unit 23 performs processing for specifying whether or not there is a connection relationship of the plurality of product areas SA. In other words, the connection relationship specifying unit 23 performs processing for specifying whether or not there is a connection relationship of a plurality of product areas SA corresponding to each of the plurality of products on the basis of the recognition results obtained by the object recognition processing of the object recognition unit 22.

The area relationship acquisition unit 24 analyzes the image IMT to acquire the area relationship information ARJ that is information related to the relationship of the respective product areas SA identified to have the connection relationship by the connection relationship specifying unit 23. Specifically, the area relationship acquisition unit 24 acquires, by analyzing the image IMT, for example, the area relationship information ARJ relating to the relationship between the two product areas SA that are adjacent to each other among the product areas SA specified to have the connection relationship by the connection relationship specifying unit 23.

Based on the attribute information ATJ stored in an attribute information storage unit 25a, the class relationship acquisition unit 25 performs processing for acquiring the class relationship information CRJ indicating the relationship of a plurality of classes set in advance in order to obtain the recognition results in the object recognition unit 22.

The recognition result correction unit 26 corrects the recognition results obtained by the object recognition unit 22 by performing the recognition result correction processing on the basis of the connection relationship of the plurality of product areas SA obtained by the connection relationship specifying unit 23, the area relationship information ARJ obtained by the area relationship acquisition unit 24, and the class relationship information CRJ obtained by the class relationship acquisition unit 25. Then, the recognition result correction unit 26 acquires a plurality of the corrected recognition results according to the number of classes recognized by the object recognition unit 22, and the number of the product areas SA specified to have a connection relationship by the connection relationship specifying unit 23. That is, the recognition result correction unit 26 acquires a plurality of the corrected recognition results by performing the recognition result correction processing for correcting the recognition results obtained by the object recognition processing of the object recognition unit 22 on the basis of the area relationship information ARJ and the class relationship information CRJ.

The evaluation unit 27 uses the plurality of the corrected recognition results obtained by the recognition result correction unit 26 and performs processing for evaluating the recognition results obtained by the object recognition processing of the object recognition unit 22, thereby acquiring the final recognition result relating to the class to which each of the plurality of products included in the plurality of product areas SA belongs.

The output unit 28 generates a display screen for displaying the final recognition result obtained by the evaluation unit 27, and outputs the generated display screen to the display device. The output unit 28 outputs the data including the final recognition result or the like obtained by the evaluation unit 27 to the external device.

### [Specific Examples of Processing Performed in the Object Recognition Device]

Next, a specific example of processing performed in the object recognition device according to the first example embodiment will be described.

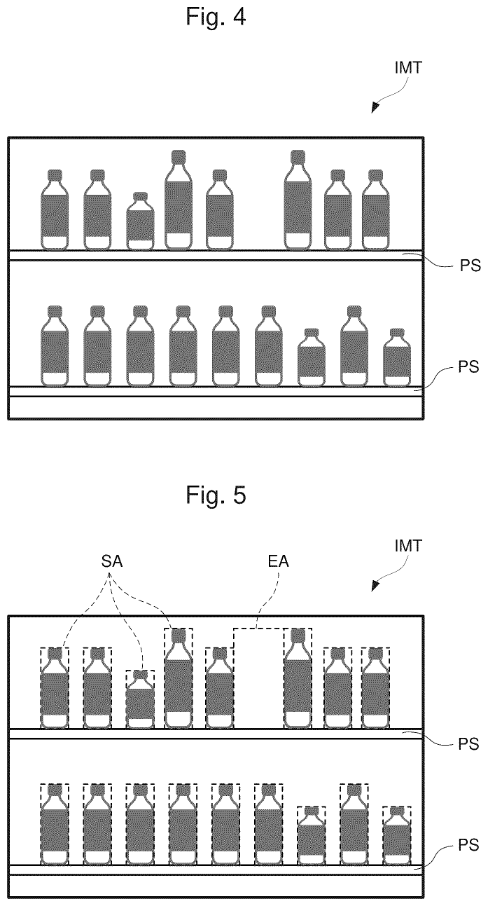

The image acquisition unit 21 acquires the image IMT by capturing the product shelf in which a plurality of products is displayed. Specifically, for example, as shown in FIG. 4, the image acquisition unit 21 acquires, as the image IMT, an image of a condition in which products such as PET bottle drinks are arranged in a line on the product shelves PS. FIG. 4 is a diagram illustrating an example of an image used in the processing of the object recognition device according to the first example embodiment.

The object recognition unit 22 detects a plurality of product areas SA and an empty area EA by performing the object recognition processing on the image IMT. According to such processing, the areas shown in FIG. 5 are detected as the product areas SA and the empty area EA, for example. FIG. 5 is a diagram for explaining a product area and an empty area detected by the processing of the object recognition device according to the first example embodiment.

In addition, the object recognition unit 22 acquires a plurality of recognition scores that are values indicating the probability of each class when each product included in the plurality of product areas SA is classified into one of a plurality of preset classes. Specifically, when four classes A to D are set in advance, the object recognition unit 22 acquires, as a recognition result of one product included in one product area SA, the recognition score RA indicating the probability of classifying the one product into the class A, the recognition score RB indicating the probability of classifying the one product into the class B, the recognition score RC indicating the probability of classifying the one product into the class C, and the recognition score RD indicating the probability of classifying the one product into the class D. In addition, when the four classes A to D are set in advance, the object recognition unit 22 acquires the recognition scores RA to RD for all the product areas SA detected in the image IMT. According to the present example embodiment, the object recognition unit 22 performs processing of adjusting a range of output values outputted through the object recognition processing by a soft max function or the like. Therefore, in the present example embodiment, the description is made assuming that the total value of the plurality of recognition scores acquired by the object recognition unit 22 becomes “1”, and each of the plurality of recognition scores takes a value equal to or larger than “0” and equal to or smaller than “1”.

The connection relationship specifying unit 23 performs processing for specifying whether or not there is a connection relationship between the plurality of product areas SA on the basis of the plurality of product areas SA and the empty area EA detected by the object recognition unit 22.

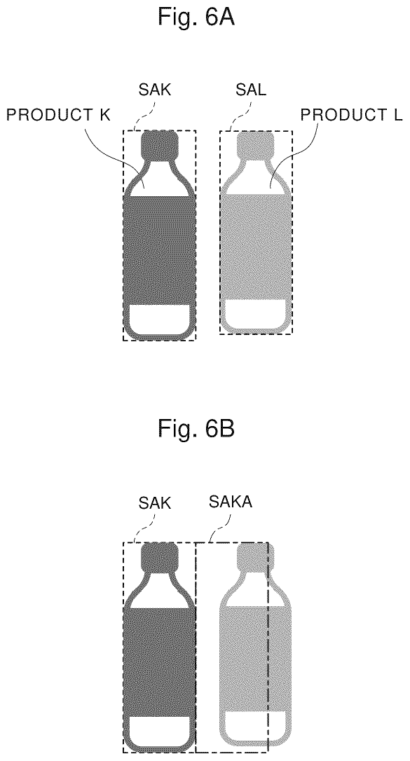

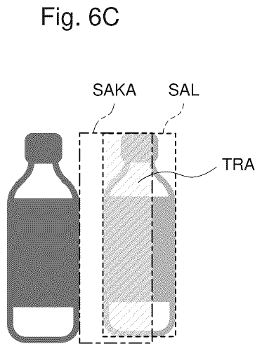

For example, description will be given of the processing of the connection relationship specifying unit 23 when the product area SAK corresponding to the product K disposed on the product shelf PS and the product area SAL corresponding to the product L disposed on the same shelf as the product K are detected by the object recognition unit 22, as shown in FIG. 6A. FIGS. 6A to 6C are diagrams for explaining the processing of specifying a connection relationship performed in the object recognition device according to the first example embodiment.

First, the connection relationship specifying unit 23 sets a rectangular area SAKA having the same size as the product area SAK at a position adjoining the product area SAK. Specifically, the connection relationship specifying unit 23 sets a rectangular area SAKA at a position adjoining the right side of the product area SAK, for example, as shown in FIG. 6B.

Next, the connection relationship specifying unit 23 detects the overlap area TRA where the product area SAL and the rectangular area SAKA overlap, and also calculates the ratio RKL of such an overlap area TRA to the product area SAL. The overlap area TRA is represented, for example, as an area shown in FIG. 6C.

Thereafter, the connection relationship specifying unit 23 determines whether or not the product area SAK and the product area SAL are adjacent to each other on the basis of the ratio RKL and a threshold THA.

When the ratio RKL is smaller than the threshold THA, the connection relationship specifying unit 23 determines that the product area SAK and the product area SAL are not adjacent to each other. Specifically, when the ratio RKL calculated according to the overlap area TRA in FIG. 6C is smaller than the threshold THA, it is determined that the product area SAK and the product area SAL are not adjacent to each other on the right side of the product area SAK. Then, when such a determination is made, the connection relationship specifying unit 23 specifies that the product area SAK and the product area SAL disposed on the product shelf PS do not have a connection relationship in the lateral direction of the product shelf PS.

In addition, when the ratio RKL is equal to or larger than the threshold THA, the connection relationship specifying unit 23 determines that the product area SAK and the product area SAL are adjacent to each other in the direction in which the rectangular area SAKA is set. Specifically, when the ratio RKL calculated according to the overlap area TRA in FIG. 6C is equal to or larger than the threshold THA, it is determined that the product area SAK and the product area SAL are adjacent to each other on the right side of the product area SAK. Then, when such a determination is made, the connection relationship specifying unit 23 specifies that the product area SAK and the product area SAL disposed on the product shelf PS have a connection relationship in the lateral direction of the product shelf PS.

The connection relationship specifying unit 23 may specify that the product area SAK and the product area SAL do not have a connection relationship (in the direction of the empty area EA) without performing the above-described processing, for example, when the empty area EA exists between the product area SAK and the product area SAL.

By analyzing the image IMT, the area relationship acquisition unit 24 acquires the area relationship information ARJ relating to the relationship between the two product areas SA that are adjacent to each other, among the product areas SA that are identified to have the connection relationship by the connection relationship specifying unit 23.

Specifically, the area relationship acquisition unit 24 acquires, from among the respective product areas SA that are specified to have the connection relationship by the connection relationship specifying unit 23, the appearance similarity information GSJ that is the information related to the similarity of the appearance and the size information SZJ that is the information related to the size relationship of the relative size, as the area relationship information ARJ corresponding to the product areas SAK and SAL, for example.

The area relationship acquisition unit 24 acquires, as the appearance similarity information GSJ, for example, an appearance similarity GSD that is a value indicating the similarity between the feature vector SAKV calculated on the basis of the color and the pattern of the product K included in the product area SAK and the feature vector SALV calculated on the basis of the color and the pattern of the product L included in the product area SAL. Note that, in this example embodiment, the appearance similarity GSD is acquired as a cosine similarity, for example, taking a value ranging from “0” to “1”. Therefore, the appearance similarity GSD is acquired as a relatively large value, for example, when the feature vectors SAKV and SALV are close, that is, when the product area SAK and SAL are similar to each other. Further, the appearance similarity GSD is acquired as a relatively small value, for example, when the feature vector SAKV and SALV are far, that is, when the product area SAK and SAL are not similar to each other.

As the size information SZJ, the area relationship acquisition unit 24 acquires information related to the comparison result obtained by comparing, for example, vertical height HK of the product area SAK and the vertical height HL of the product area SAL. Specifically, as the size information SZJ, for example, the area relationship acquisition unit 24 acquires information indicating that the height HK is larger than the height HL (HK>HL), that the height HK and the height HL are equal (HK=HL), or that the height HK is smaller than the height HL (HK<HL). According to the present example embodiment, when the products K and L are disposed on the same shelf of the product shelf PS and at least one lower portion of the products K and L is hidden by a shield such as an advertisement and a price tag, the area relationship acquisition unit 24 may acquire information related to the result of comparing the top coordinate value in the vertical direction of the product area SAK with the top coordinate value in the vertical direction of the product area SAL as the size information SZJ.

Based on the attribute information ATJ stored in the attribute information storage unit 25a, the class relationship acquisition unit 25 performs processing for acquiring the class relationship information CRJ indicating the relationship of the classes A to D that are set in advance in order to obtain the recognition results in the object recognition unit 22.

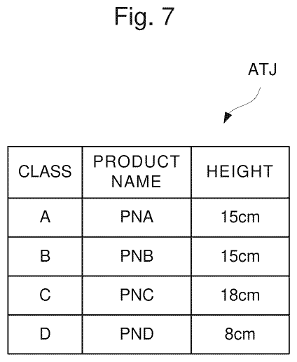

When the four classes A to D are set in the object recognition unit 22, the attribute information ATJ may be created as information shown in FIG. 7, for example. FIG. 7 is a diagram illustrating an example of the attribute information used in acquiring the class relationship information.

The “PRODUCT NAME” of the attribute information ATJ indicates that the name of the product belonging to the class A is “PNA”, the name of the product belonging to the class B is “PNB”, the name of the product belonging to the class C is “PNC”, and the name of the product belonging to the class D is “PND”. Further, the “HEIGHT” of the attribute information ATJ indicates that the height of the product belonging to the class A is “15 cm”, that the height of the product belonging to the class B is “15 cm”, that the height of the product belonging to the class C is “18 cm”, and that the height of the product belonging to the class D is “8 cm”.

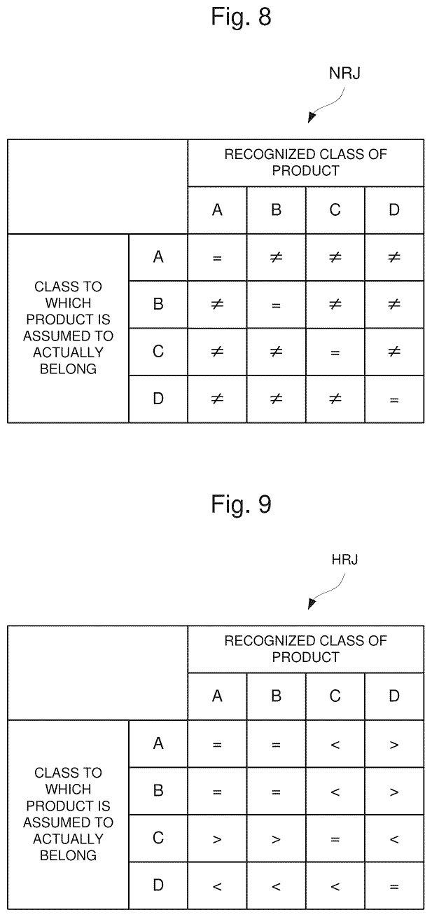

When the attribute information ATJ of FIG. 7 is stored in the attribute information storage unit 25a, the class relationship acquisition unit 25 performs processing for acquiring, as the class relationship information CRJ, for example, the product name relationship information NRJ as shown in FIG. 8 and the height relationship information HRJ as shown in FIG. 9. FIGS. 8 and 9 are diagrams for explaining an example of information that may be included as the class relationship information.

The product name relationship information NRJ of FIG. 8 corresponds to information indicating whether or not the name of the product assumed to actually belong to one of the four classes A to D and the name of the product recognized by the object recognition unit 22 agree with each other. Specifically, the product name relationship information NRJ of FIG. 8 indicates that the name of the product actually assumed to belong to the class A agrees with the name of the product that the object recognition unit 22 recognized as the class A, and does not agree with the name of the product that the object recognition unit 22 recognized as one of the class B, the class C, and the class D.

According to the present example embodiment, the class relationship acquisition unit 25 may acquire the inter-class similarity CSD calculated based on the images of the products belonging to the classes A to D as the product name relationship information NRJ, for example, instead of the information illustrated in FIG. 8. The details of the inter-class similarity CSD will be described later.

The height relationship information HRJ of FIG. 9 corresponds to information indicating the relationship between the height of the product assumed to actually belong to one of the four classes A to D and the height of the product recognized by the object recognition unit 22. Specifically, the height relationship information HRJ of FIG. 9 indicates that the height of the product actually assumed to belong to the class A is equal to the height of the product that the object recognition unit 22 recognized as one of the class A and the class B, is smaller than the height of the product that the object recognition unit 22 recognized as the class C, and is larger than the height of the product that the object recognition unit 22 recognized as the class D.

The recognition result correction unit 26 corrects the recognition result obtained by the object recognition unit 22 by performing the recognition result correction processing on the basis of the connection relationship of the plurality of product areas SA obtained by the connection relationship specifying unit 23, the area relationship information ARJ obtained by the area relationship acquisition unit 24, and the class relationship information CRJ obtained by the class relationship acquisition unit 25.

Here, a specific example of the recognition result correction processing will be described. In the following, for the product areas SAK and SAL that are specified to have the connection relationship by the connection relationship specifying unit 23, description will be given of the case in which the recognition result of the product L included in the product area SAL is corrected based on the recognition result of the product K included in the product area SAK. In the following description, it is assumed that the recognition scores RLA, RLB, RLC and RLD indicating the probability of classifying the product L into the classes A to D are obtained as the recognition result in which the object recognition unit 22 recognizes the product L included in the product area SAL. Further, in the following, it is assumed that the area relationship information ARJ including the appearance similarity information GSJ and the size information SZJ is acquired. Further, in the following, it is assumed that the class relationship information CRJ including the product name relationship information NRJ illustrated in FIG. 8 and the height relationship information HRJ illustrated in FIG. 9 is acquired.

First, processing of acquiring the correction value based on the appearance similarity information GSJ included in the area relationship information ARJ and the product name relationship information NRJ included in the class relationship information CRJ will be described. In the following, the correction value obtained by such processing is referred to as a correction value HVA comprehensively.

The recognition result correction unit 26 acquires correction value HVA for correcting the recognition scores RLA, RLB, RLC and RLD, for example, when it is assumed that the product K actually belongs to the class A on the basis of the appearance similarity information GSJ and the product name relationship information NRJ.

Specifically, when the appearance similarity GSD included in the appearance similarity information GSJ is a large value (a value close to “1” or “1”), for example, the recognition result correction unit 26 determines that the probability that the product L belongs to the class A is high and the probability that the product L belongs to any of the classes B to D is low on the basis of the product name relationship information NRJ. When such a determination is made, the recognition result correction unit 26 acquires “0” as the correction value HVA for the case where the product K belongs to the class A and the product L belongs to the class A. In addition, when the determination is performed as described above, the recognition result correction unit 26 acquires a value (−GSD) obtained by converting the appearance similarity GSD into a negative value as the correction value HVA for the case where the product K belongs to the class A and the product L belongs to any of the classes B to D.

In addition, for example, when the appearance similarity GSD included in the appearance similarity information GSJ is a small value (a value close to “0” or “0”), the recognition result correction unit 26 determines that the probability that the product L belongs to the class A is low and the probability that the product L belongs to any of the classes B to D is high on the basis of the product name relationship information NRJ. When such a determination is made, the recognition result correction unit 26 acquires a value (−GSD) obtained by converting the appearance similarity GSD into a negative value as the correction value HVA for the case where the product K belongs to the class A and the product L belongs to the class A. When the determination is performed as described above, the recognition result correction unit 26 acquires “0” as the correction value HVA for the case where the product K belongs to the class A and the product L belongs to any one of the classes B to D.

The recognition result correction unit 26 acquires the correction value HVA for correcting the recognition scores RLA, RLB, RLC and RLD, for the cases where it is assumed that the product K actually belongs to the class B, where it is assumed that the product K actually belongs to the class C, and where it is assumed that the product K actually belongs to the class D, respectively, by performing the processing similar to the processing described above.

That is, according to the above-described processing, the recognition result correction unit 26 acquires the correction value HVA for correcting the recognition scores obtained through the object recognition processing of the object recognition unit 22 on the basis of the appearance similarity information GSJ and the product name relationship information NRJ. In addition, according to the above-described processing, when there is no discrepancy between the magnitude of the value of the appearance similarity GSD and the relation between the classes A to D indicated by the product name relationship information NRJ, “0” is acquired as the correction value HVA. In addition, according to the above-described processing, when there is a discrepancy between the magnitude of the value of the appearance similarity GSD and the relationship between the classes A to D indicated by the product name relationship information NRJ, “−GSD” is acquired as the correction value HVA.

According to present example embodiment, for example, the recognition result correction unit 26 may acquire the correction value HVA using a function in which a value equal to or smaller than zero is calculated according to the difference between the value of the inter-class similarity CSD, which is obtained based on the relationship between the classes A to D indicated by the product name relationship information NRJ or the like, and the value of the appearance similarity GSD. The inter-class similarity CSD may be set to “1” when the product names of the products K and L coincide, and “0” when the product names of the products K and L do not coincide. Alternatively, for example, the inter-class similarity degree CSD may be set as a value of “0” to “1” indicating the similarity in two feature vectors among a feature vector calculated from an image of a product actually belonging to the class A, a feature vector calculated from an image of the product actually belonging to the class B, a feature vector calculated from the image of the product actually belonging to the class C, and a feature vector calculated from the image of the product actually belonging to the class D. Further, the above-described function may be realized by using a machine learning model that is preliminarily learned to output a correction value HVA according to an input. For example, the above-described function may be configured to include a neural network, and may be configured to output a correction value HVA in response to an input of a comparison result of the product name of the product areas SAK and SAL, and the relationship between the classes A to D indicated by the product name relationship information NRJ. Then, according to the configuration described above, for example, it is possible to acquire “0” as the correction value HVA when CSD=0.7 and GSD=0.7. Further, according to the configuration described above, for example, it is possible to acquire “−0.1” as the correction value HVA when CSD=0.7 and GSD=0.8. Further, according to the configuration described above, for example, it is possible to obtain “−0.3” as the correction value HVA when CSD=0.7 and GSD=0.4.

Next, processing of acquiring the correction value based on the size information SZJ included in the area relationship information ARJ and the height relationship information HRJ included in the class relationship information CRJ will be described. In the following, the correction value obtained by such processing is referred to as a correction value HVB comprehensively.

The recognition result correction unit 26 acquires the correction value HVB for correcting the recognition scores RLA, RLB, RLC and RLD on the basis of the size information SZJ and the height relationship information HRJ, for example, when it is assumed that the product K actually belongs to the class A.

Specifically, for example, when the information indicating that HK=HL is included in the size information SZJ, the recognition result correction unit 26 determines that the probability that the product L belongs to either the class A or the class B is high and the probability that the product L belongs to either the class C or the class D is low on the basis of the height relationship information HRJ. When such a determination is made, the recognition result correction unit 26 acquires “0” as the correction value HVB for the case where the product K belongs to the class A and the product L belongs to any of the classes A and B. When the determination is performed as described above, the recognition result correction unit 26 acquires “−1” as the correction value HVB for the case where the product K belongs to the class A and the product L belongs to any of the classes C and D.

In addition, for example, when the information indicating that HK>HL is included in the size information SZJ, the recognition result correction unit 26 determines that the probability of the product L belonging to the class D is high and the probability of the product L belonging to any of the classes A, B, or C is low on the basis of the height relationship information HRJ. When such a determination is made, the recognition result correction unit 26 acquires “0” as the correction value HVB for the case where the product K belongs to the class A and the product L belongs to the class D. When the determination is performed as described above, the recognition result correction unit 26 acquires “−1” as the correction value HVB for the case where the product K belongs to the class A and the product L belongs to any one of the classes A to C.

In addition, for example, when the information indicating that HK<HL is included in the size information SZJ, the recognition result correction unit 26 determines that the probability of the product L belonging to the class C is high and the probability of the product L belonging to any of the classes A, B, or D is low on the basis of the height relationship information HRJ. When such a determination is made, the recognition result correction unit 26 acquires “0” as the correction value HVB for the case where the product K belongs to the class A and the product L belongs to the class C. When the determination is performed as described above, the recognition result correction unit 26 acquires “−1” as the correction value HVB for the case where the product K belongs to the class A and the product L belongs to any of the classes A, B, or D.

The recognition result correction unit 26 acquires the correction value HVB for correcting the recognition scores RLA, RLB, RLC and RLD, when it is assumed that the product K actually belongs to the class B, when it is assumed that the product K actually belongs to the class C, and when it is assumed that the product K actually belongs to the class D, respectively, by performing the processing similar to the processing described above.

That is, according to the above-described processing, the recognition result correction unit 26 acquires the correction value HVB for correcting the recognition scores obtained by the object recognition processing of the object recognition unit 22 on the basis of the size information SZJ and the height relationship information HRJ. In addition, according to the above-described processing, when there is no discrepancy between the comparison result of the height HK and HL included in the size information SZJ and the relationships between the classes A to D indicated by the height relationship information HRJ, “0” is acquired as the correction value HVB. Further, according to the above-described processing, when there is a discrepancy between the comparison result of the height HK and HL included in the size information SZJ and the relationships between the classes A to D indicated by the height relationship information HRJ, “−1” is acquired as the correction value HVB.

According to the present example embodiment, for example, the recognition result correction unit 26 may acquire the correction value HVB using a function that calculates a value larger than “0” when there is no discrepancy, and calculates a negative value when there is the discrepancy. Further, the above-described function may be realized by using a machine learning model that is preliminarily learned so as to output a correction value HVB according to an input. For example, the function may be configured to include a neural network, and may be configured to output a correction value HVB in response to an input of a comparison result of the size of the product areas SAK and SAL and a relationship between the classes A to D indicated by the height relationship information HRJ.

The recognition result correction unit 26 corrects the recognition result obtained by the object recognition unit 22 by performing the recognition result correction processing using the correction value HVA and the correction value HVB.

Specifically, the recognition result correction unit 26 performs processing of adding the correction value HVA and the correction value HVB to each of the recognition scores RLA, RLB, RLC and RLD, for example, as the recognition result correction processing. Then, according to such processing, the corrected recognition score ARLA corresponding to RLA+HVA+HVB, the corrected recognition score ARLB corresponding to RLB+HVA+HVB, the corrected recognition score ARLC corresponding to RLC+HVA+HVB, and the corrected recognition score ARLD corresponding to RLD+HVA+HVB are acquired. In addition, the corrected recognition scores ARLA to ARLD are acquired for the classes to which the product K assumed to belong. That is, the recognition result correction unit 26 acquires the corrected recognition scores ARLA to ARLD for the classes A to D to which the product K assumed to belong.

The evaluation unit 27 uses the plurality of the corrected recognition results obtained by the recognition result correction unit 26 and performs processing for evaluating the recognition results obtained by the object recognition unit 22 to obtain the final recognition result related to the class in which each product included in the plurality of product area SA belongs.

Here, a specific example of the processing related to the evaluation of the recognition results obtained by the object recognition unit 22 will be described. In the description below, it is assumed that recognition scores RKA, RKB, RKC, and RKD, which indicate the probability of classifying the product K into the classes A to D, were obtained as the recognition results of the product K included in the product area SAK by the object recognition unit 22. Further, in the following, description will be mainly given of the case of performing the processing using the recognition scores RKA to RKD and the corrected recognition scores ARLA to ARLD.

The evaluation unit 27 performs, for example, processing of adding the recognition score RKA to each of the corrected recognition scores ARLA to ARLD obtained when it is assumed that the product K actually belongs to the class A. Then, according to such processing, the evaluation value EVAA corresponding to RKA+ARLA, the evaluation value EVAB corresponding to RKA+ARLB, the evaluation value EVAC corresponding to RKA+ARLC, and the evaluation value EVAD corresponding to RKA+ARLD, are acquired.

Further, the evaluation unit 27 performs, for example, processing of adding the recognition score RKB to each of the corrected recognition scores ARLA to ARLD obtained when it is assumed that the product K actually belongs to the class B. Then, according to such processing, the evaluation value EVBA corresponding to RKB+ARLA, the evaluation value EVBB corresponding to RKB+ARLB, the evaluation value EVBC corresponding to RKB+ARLC, and the evaluation value EVBD corresponding to RKB+ARLD, are acquired.

Further, the evaluation unit 27 performs, for example, processing of adding the recognition score RKC to each of the corrected recognition scores ARLA to ARLD obtained when it is assumed that the product K actually belongs to the class C. Then, according to such processing, the evaluation value EVCA corresponding to RKC+ARLA, the evaluation value EVCB corresponding to RKC+ARLB, the evaluation value EVCC corresponding to RKC+ARLC, and the evaluation value EVCD corresponding to RKC+ARLD, are acquired.

Further, the evaluation unit 27 performs, for example, processing of adding the recognition score RKD to each of the corrected recognition scores ARLA to ARLD obtained when it is assumed that the product K actually belongs to the class D. Then, according to such a processing, the evaluation value EVDA corresponding to RKD+ARLA, the evaluation value EVDB corresponding to RKD+ARLB, the evaluation value EVDC corresponding to RKD+ARLC, and the evaluation value EVDD corresponding to RKD+ARLD, are acquired.

The evaluation unit 27 determines the evaluation value EVM with the largest value by comparing the 16 evaluation values EVAA to EVAD, EVBA to EVBD, EVCA to EVCD, and EVDA to EVDD obtained by the processing described above. Then, the evaluation unit 27 acquires information indicating the class of the products K and L corresponding to the evaluation value EVM as the final recognition result. Specifically, for example, when EVM=EVAB, the information indicating that the product K belongs to the class A and the product L belongs to the class B is obtained as the final recognition result.

On the other hand, in the present example embodiment, for example, when N (N≥2) pieces of products are arranged side by side in a horizontal row on the product shelf PS, i.e., when the N product areas have the connection relationship in the lateral direction, the evaluation unit 27 performs the processing using dynamic programming according to formulas (1) and (2) below. Then, the evaluation unit 27 acquires the information indicating the class of each of the N products that maximizes the evaluation value EV of formula (1) below as the final recognition result.

$$[ Formula 1 ]$$

$$EV = {s}_{1} ( {x}_{1} ) + {\tilde{s}}_{2} ( {x}_{1} , {x}_{2} ) + … + {\tilde{s}}_{N} ( {x}_{N - 1} , {x}_{N} ) \qquad ( 1 )$$

$$[ Formula 2 ]$$

$${\tilde{s}}_{j} ( {x}_{j - 1} , {x}_{j} ) = {s}_{j} ( {x}_{j} ) + {H}_{size} ( {x}_{j - 1} , {x}_{j} ) + {H}_{sim} ( {x}_{j - 1} , {x}_{j} ) \qquad ( 2 )$$

In the above-described formula (1), x₁ indicates the class in which the first product from the left of the product shelf PS is actually assumed to belong, and s₁(x₁) indicates the recognition score corresponding to the class of x₁. Further, in the above-described formulas (1) and (2), s^{˜}ⱼ(xⱼ₋₁, xⱼ) indicates the corrected recognition score in the combination of the class in which j−1(2≤j≤N)th product from the left of the product shelf PS is estimated to actually belong and the class in which the jth product from the left of the product shelf PS is recognized to belong. Further, in the above-described formula (2), xⱼ indicates the class in which the j(2≤j≤N)th product is estimated to belong from the left of the product shelf PS, and sⱼ(xⱼ) indicates the recognition score corresponding to the class of xⱼ. Further, in the above-described formula (2), H_{size}(xⱼ₋₁, xⱼ) corresponds to the correction value HVB calculated by applying the above-described method to (j−1)th and jth products from the left of the product shelf. Further, in the above-described formula (2), Hₛᵢₘ(xⱼ₋₁, xⱼ) corresponds to the correction value HVA calculated by applying the above-mentioned method to (j−1)th and jth products from the left of the product shelf.

Here, an outline of the processing using the dynamic programming method according to the above-described formulas (1) and (2) will be described.

First, the evaluation unit 27 acquires 16 evaluation values EV similar to the above-described evaluation values EVAA to EVDD by performing processing according to the above-described formulas (1) and (2) for the first product SH1 from the left of the product shelf PS and the second product SH2 from the left of the product shelf PS, and determines the evaluation value EVM having the largest value out of the 16 evaluation values EV. Then, for example, when EVM=EVAB, the evaluation unit 27 acquires the estimation result that the product SH1 belongs to the class A and the product SH2 belongs to the class B.

Next, the evaluation unit 27 performs the processing according to the above-described formulas (1) and (2) for the product SH2 and the third product SH3 from the left of the product shelf PS. When performing the processing according to the above-described formulas (1) and (2), for example, if the estimated result that the product SH2 belongs to the class B is obtained in advance, the evaluation unit 27 acquires four evaluation values EV similar to the above-described evaluation values EVBA to EVBD and determines the evaluation value EVM having the largest value out of the four evaluation values EV. Then, for example, when EVM=EVBD, the evaluation unit 27 acquires the estimation result that the product SH3 belongs to the class D.

Thereafter, the evaluation unit 27 sequentially performs the processing according to the above formulas (1) and (2) from the left product to the right product of the product shelf PS to obtain an estimation result relating to the class to which each of the N products arranged in the product shelf PS belongs.

That is, according to the above-described processing, the evaluation unit 27 acquires the estimation result of the class to which each of the N products arranged in the product shelf PS belongs, with which the evaluation value EV of the above-described formula (1) becomes the largest value, as the final recognition result.

The output unit 28 generates a display screen for displaying the final recognition result obtained by the evaluation unit 27, and outputs the generated display screen to the display device. Also, the output unit 28 outputs the data including the final recognition result or the like obtained by the evaluation unit 27 to the external device.

In the present example embodiment, for the class to which each of the N products arranged on the product shelf PS belongs, the class according to the final recognition result obtained by the evaluation unit 27 is displayed. In addition, the class according to the recognition results before the correction, obtained by the object recognition unit 22, may be displayed together, for example.

Further, in the present example embodiment, for the class to which each of the N products arranged on the product shelf PS belongs, for example, a display screen may be displayed to allow modification of the final recognition result based on the user's subjectivity or based on the processing results obtained by processing such as character recognition. Further, in the present example embodiment, when the final recognition result is corrected, for example, the processing of the recognition result correction unit 26 and the evaluation unit 27 may be performed again in a condition where the class of each product that was corrected is fixed among the corrected recognition results.

Further, in the present example embodiment, when the final recognition result is modified based on the user's subjectivity, for example, the recognition result may be displayed after re-modification, in which the modified recognition result is further modified by character recognition or other processing. Further, in the present example embodiment, a dialogue or the like may be displayed which can allow the user to determine whether or not the recognition result after the re-correction is acceptable or not.

### [Processing Flow]

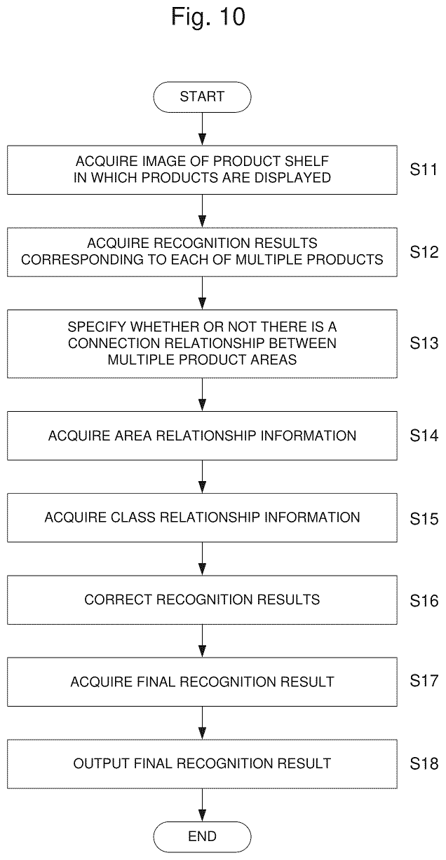

Next, a flow of processing performed in the object recognition device will be described. FIG. 10 is a flowchart for explaining processing performed in the object recognition device according to the first example embodiment.

First, the image acquisition unit 21 acquires an image by capturing the product shelf in which a plurality of products is displayed (step S11).

Next, the object recognition unit 22 acquires the recognition results corresponding to each of the plurality of products included in the image by performing the object recognition processing on the image obtained by the step S11 (step S12). Specifically, the above-described recognition result includes, for example, a plurality of product areas and a recognition score which is a value indicating the probability of each class when the products included in the plurality of product areas are classified into any of a plurality of preset classes.

Subsequently, the connection relationship specifying unit 23 performs processing for specifying whether or not there is the connection relationship between the plurality of product areas in the recognition results obtained by the step S12 (step S13).

Subsequently, the area relationship acquisition unit 24 acquires the area relationship information relating to the relationship between two product areas adjacent to each other among the product areas identified to have the connection relationship by the step S13 on the basis of the image obtained by the step S11 (step S14).

Subsequently, based on the attribute information stored in the attribute information storage unit 25a, the class relationship acquisition unit 25 performs processing for acquiring the class relationship information representing the relationship of a plurality of classes set in advance to obtain the recognition results by the object recognition processing of the step S12 (step S15).

Subsequently, the recognition result correction unit 26 corrects the recognition score included in the recognition results obtained by the step S12 by performing the recognition result correction processing on the basis of the connection relationship of the plurality of product areas specified by the step S13, the area relationship information obtained by the step S14, and the class relationship information obtained by the step S15 (step S16). According to this processing, the recognition result correction unit 26 acquires a plurality of the corrected recognition results according to the number of classes recognized by the object recognition unit 22, and the number of the product areas SA identified to have the connection relationship by the connection relationship specifying unit 23.

Subsequently, the evaluation unit 27 uses the plurality of the corrected recognition results obtained by the step S16 and performs processing for evaluating the recognition results obtained by the step S12 to acquire the final recognition result relating to the class to which each of the products included in the plurality of product areas belongs (step S17).

Finally, the output unit 28 outputs the final recognition result obtained by the step S17 to the display device and the external device or the like (step S18).

As described above, according to the present example embodiment, the recognition results of the plurality of objects are acquired by performing the object recognition processing on an image including a plurality of objects, a plurality of corrected recognition results are acquired by correcting the recognition results obtained by the object recognition processing on the basis of the area relationship information and the class relationship information, and the recognition results obtained by the object recognition processing are evaluated using the plurality of the corrected recognition results, thereby obtaining the final (optimized) recognition result. Therefore, according to the present example embodiment, it is possible to improve the recognition accuracy of individual objects in a plurality of objects included in an image.

### [Modifications]

Hereinafter, modifications to the above example embodiment will be described. For the sake of simplicity, specific description of the part to which the above-described processing can be applied shall be omitted as appropriate.

### (Modification 1)

The connection relationship specifying unit 23 may, for example, specify whether or not the product area SAK and the product area SAL disposed across the shelf plate of the product shelf PS have a connection relationship in the vertical direction of the product shelf PS by performing the processing similar to the processing described above while setting the rectangular area SAKA at a position adjoining the upper side or the lower side of the product area SAK.

### (Modification 2)

The recognition result correction unit 26 may be configured, for example, as a learned machine learning model having a Graph convolutional neural network and may be configured to output a correction value according to graph data inputted to the machine learning model. Further, the above-described graph data may be configured, for example, as data in which a plurality of nodes corresponding to each of a plurality of products included in the image IMT is connected by edges, and information such as appearance similarity information GSJ and size information SZJ indicating a relationship of a plurality of product areas corresponding to each of the plurality of products is embedded as an edge feature quantity.

### (Modification 3)

For example, when the N products on the product shelf PS are arranged side by side in a row, i.e., when the N product areas have a connection relationship in the lateral direction, the evaluation unit 27 may perform the processing using dynamic programming according to formulas (3) and (4) below. Then, the evaluation unit 27 may acquire the information indicating the class of each of the N products that minimizes the cost value CV of formula (3) below as the final recognition result.

$$[ Formula 3 ]$$

$$CV = {r}_{1} ( {x}_{1} ) + {\tilde{h}}_{2} ( {x}_{1} , {x}_{2} ) + {\tilde{h}}_{3} ( {x}_{2} , {x}_{3} ) + … + {\tilde{h}}_{N} ( {x}_{N - 1} , {x}_{N} ) \qquad ( 3 )$$

$$[ Formula 4 ]$$

$${\tilde{h}}_{k} ( {x}_{k - 1} , {x}_{k} ) = {r}_{k} ( {x}_{k} ) + {M}_{size} ( {x}_{k - 1} , {x}_{k} ) + {M}_{sim} ( {x}_{k - 1} , {x}_{k} ) \qquad ( 4 )$$

In the above-described formula (3), x₁ indicates the class in which the first product from the left of the product shelf PS is actually assumed to belong, and r₁(x₁) indicates the value obtained by subtracting the recognition score corresponding to the class of x₁ from “1.0”. Further, in the above-described formulas (3) and (4), h^{˜}ₖ(xₖ₋₁, xₖ) indicate the corrected recognition score in the combination of the class in which k−1(2≤k≤N)th product from the left of the product shelf PS is estimated to actually belong and the class in which the kth product from the left of the product shelf PS is recognized to belong. Further, in the above-described formula (4), xₖ indicates the class in which the kth product from the left of the product shelf PS is estimated to belong, and rₖ(xₖ) indicates the value obtained by subtracting the recognition score corresponding to the class of xₖ from “1.0”. In the above-described formula (4), M_{size}(xₖ₋₁, xₖ) indicates a correction value that becomes “0” when the height (size) matches and becomes “1” when the height (size) does not match for (k−1)th and kth products from the left of the product shelf PS. Further, in above-described formula (4), Mₛᵢₘ(xₖ₋₁, xₖ) is a correction value for the (k−1)th and kth products from the left of the product shelf PS, that becomes “0” when they belong to the same class as each other, and becomes the value according to the following formula (5) when they belong to different classes from each other.

$$[ Formula 5 ]$$

$${M}_{sim} ( {x}_{k - 1} , {x}_{k} ) = \frac{max ( cos ( {ϕ}_{k - 1} , {ϕ}_{k} ) - 0.5 , 0 )}{0.5} \qquad ( 5 )$$

In the above-described formula (5), (ϕₖ₋₁, ϕₖ) indicates the angle between the feature vector of the product area corresponding to (k−1)th product from the left of the product shelf PS and the feature vector of the product area corresponding to the kth product from the left of the product shelf PS.

### Second Example Embodiment

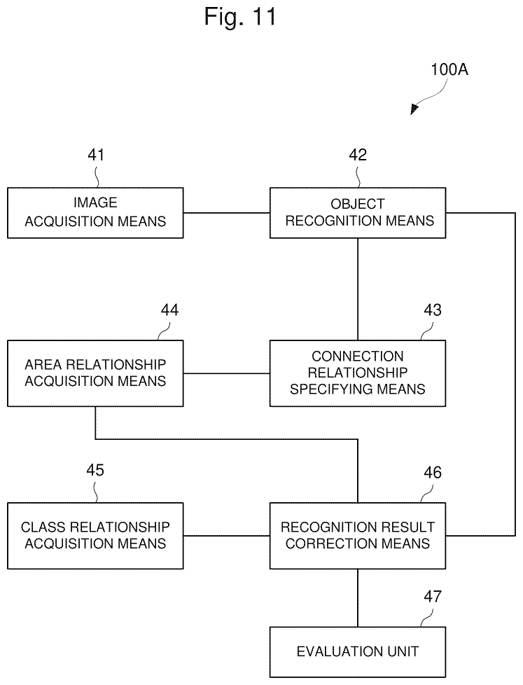

FIG. 11 is a block diagram showing a functional configuration of an object recognition device according to a second example embodiment.

The object recognition device 100A according to this example embodiment has the same hardware configuration as that of the object recognition device 100. Further, the object recognition device 100A includes an image acquisition means 41, an object recognition means 42, a connection relationship specifying means 43, an area relationship acquisition means 44, a class relationship acquisition means 45, a recognition result correction means 46, and an evaluation means 47.

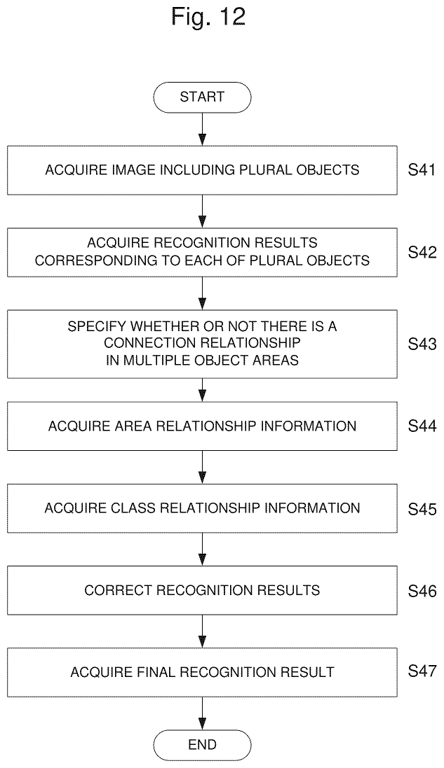

FIG. 12 is a flowchart for explaining processing performed in the object recognition device according to the second example embodiment.

The image acquisition means 41 acquires an image including a plurality of objects (step S41).

The object recognition means 42 acquires recognition results corresponding to each of a plurality of objects included in the image by performing object recognition processing on the image (step S42).

The connection relationship specifying means 43 performs processing for specifying whether or not there is a connection relationship of a plurality of object areas corresponding to each of the plurality of objects, based on the recognition results obtained by the object recognition processing (step S43).

The area relationship acquiring means 44 acquires the area relationship information that is information related to a relationship of each object areas identified to have the connection relationship (step S44).

The class relationship obtaining means 45 acquires the class relationship information which is information indicating a relationship of a plurality of classes set in advance in order to obtain the recognition results by the object recognition processing (step S45).

The recognition result correction means 46 acquires a plurality of the corrected recognition results by performing recognition result correction processing for correcting the recognition results obtained by the object recognition processing based on the area relationship information and the class relationship information (step S46).

The evaluation means 47 acquires the final recognition result relating to the class to which each of the plurality of objects belongs, by evaluating the recognition results obtained by the object recognition processing using the plurality of the corrected recognition result (step S47).

According to this example embodiment, it is possible to improve the recognition accuracy of individual objects in a plurality of objects included in an image.

A part or all of the example embodiments described above may also be described as the following supplementary notes, but not limited thereto.

### (Supplementary Note 1)

An object recognition device comprising:
an image acquisition means configured to acquire an image including a plurality of objects;
an object recognition means configured to acquire recognition results corresponding to each of the plurality of objects included in the image by performing object recognition processing on the image;
a connection relationship specifying means configured to perform a processing for specifying whether or not there is a connection relationship of a plurality of object areas corresponding to the plurality of objects based on the recognition results obtained by the object recognition processing;
an area relationship acquisition means configured to acquire area relationship information that is information related to a relationship of each object areas identified to have the connection relationship;
a class relationship acquisition means configured to acquire class relationship information that is information indicating a relationship of a plurality of classes set in advance in order to obtain the recognition results by the object recognition processing;
a recognition result correction means configured to acquire a plurality of corrected recognition results by performing recognition result correction processing for correcting the recognition results obtained by the object recognition processing based on the area relationship information and the class relationship information; and
an evaluation means configured to acquire a final recognition result relating to the class to which each of the plurality of objects belongs, by evaluating the recognition results obtained by the object recognition processing using the plurality of the corrected recognition result.

### (Supplementary Note 2)

The object recognition device according to Supplementary note 1, wherein the object recognition means acquires a recognition score as the recognition result by performing the object recognition processing on the image, the recognition score being a value indicating a probability of each class when each of the plurality of objects is classified into one of the plurality of classes.

### (Supplementary Note 3)

The object recognition device according to Supplementary note 2, wherein the area relationship acquisition means acquires appearance similarity information as the area relationship information corresponding to the two object areas having the connection relationship, the appearance similarity information being information relating to similarity of appearances between objects included in two object areas.

### (Supplementary Note 4)

The object recognition device according to Supplementary note 3, wherein the class relationship acquisition means acquires object name relationship information as the class relationship information, the object name relationship information indicating whether or not a name of the object assumed to actually belong to one of the plurality of classes, and a name of the object recognized by the object recognition process agree with each other.

### (Supplementary Note 5)

The object recognition device according to Supplementary note 4, wherein the recognition result correction means acquires a correction value for correcting the recognition score obtained by the object recognition processing based on the appearance similarity information and the object name relationship information.

### (Supplementary Note 6)

The object recognition device according to Supplementary note 2, wherein the area relationship acquisition means acquires size information as the area relationship information corresponding to the two object areas having the connection relationship, the size information being information relating to a magnitude relationship of relative sizes of the objects included in the two object areas.

### (Supplementary Note 7)

The object recognition device according to Supplementary note 6, wherein the class relationship acquisition means acquires height relationship information as the class relationship information, the height relationship information being information indicating a relationship between a height of the object assumed to actually belong to one of the plurality of classes, and a height of the object recognized by the object recognition processing.

### (Supplementary Note 8)

The object recognition device according to Supplementary note 7, wherein the recognition result correction means acquires a correction value for correcting the recognition score obtained by the object recognition processing based on the size information and the height relationship information.

(Supplementary note 9)

An object recognition method comprising:
acquiring an image including a plurality of objects;
acquiring recognition results corresponding to each of the plurality of objects included in the image by performing object recognition processing on the image;
performing processing for specifying whether or not there is a connection relationship of a plurality of object areas corresponding to the plurality of objects based on the recognition results obtained by the object recognition processing;
acquiring an area relationship information that is information related to a relationship of each object areas identified to have the connection relationship;
acquiring a class relationship information which is information indicating a relationship of a plurality of classes set in advance in order to obtain the recognition results by the object recognition processing;
acquiring a plurality of corrected recognition results by performing recognition result correction processing for correcting the recognition results obtained by the object recognition processing based on the area relationship information and the class relationship information; and
acquiring a final recognition result relating to the class to which each of the plurality of objects belongs, by evaluating the recognition results obtained by the object recognition processing using the plurality of the corrected recognition result.

### (Supplementary Note 10)

A recording medium recording a program, the program causing a computer to execute:
acquiring an image including a plurality of objects;
acquiring recognition results corresponding to each of the plurality of objects included in the image by performing object recognition processing on the image;
performing processing for specifying whether or not there is a connection relationship of a plurality of object areas corresponding to the plurality of objects based on the recognition results obtained by the object recognition processing;
acquiring an area relationship information that is information related to a relationship of each object areas identified to have the connection relationship;
acquiring a class relationship information which is information indicating a relationship of a plurality of classes set in advance in order to obtain the recognition results by the object recognition processing;
acquiring a plurality of corrected recognition results by performing recognition result correction processing for correcting the recognition results obtained by the object recognition processing based on the area relationship information and the class relationship information; and
acquiring a final recognition result relating to the class to which each of the plurality of objects belongs, by evaluating the recognition results obtained by the object recognition processing using the plurality of the corrected recognition result.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

21 Image acquisition unit
22 Object recognition unit
23 Connection relationship specifying unit
24 Area relationship acquisition unit
25 Class relationship acquisition unit
26 Recognition result correction unit
27 Evaluation unit
28 Output unit
100 Object recognition device

What is claimed is:

1. An object recognition device comprising:
a memory configured to store instructions; and
a processor configured to execute the instructions to:
acquire an image including a plurality of objects;
acquire recognition results corresponding to each of the plurality of objects included in the image by performing object recognition processing on the image;
perform processing for specifying whether or not there is a connection relationship of a plurality of object areas corresponding to the plurality of objects based on the recognition results obtained by the object recognition processing;
acquire area relationship information that is information related to a relationship of each object areas that are identified to have the connection relationship;
acquire class relationship information which is information indicating a relationship of a plurality of classes set in advance in order to obtain the recognition results by the object recognition processing;
acquire a plurality of corrected recognition results by performing recognition result correction processing for correcting the recognition results obtained by the object recognition processing based on the area relationship information and the class relationship information; and
acquire a final recognition result relating to the class to which each of the plurality of objects belongs, by evaluating the recognition results obtained by the object recognition processing using the plurality of the corrected recognition result.

2. The object recognition device according to claim 1, wherein, the processor acquires a recognition score as the recognition result by performing the object recognition processing on the image, the recognition score being a value indicating a probability of each class when each of the plurality of objects is classified into one of the plurality of classes.

3. The object recognition device according to claim 2, wherein the processor acquires appearance similarity information as the area relationship information corresponding to the two object areas having the connection relationship, the appearance similarity information being information relating to similarity of appearances between objects included in two object areas.

4. The object recognition device according to claim 3, wherein the processor acquires object name relationship information as the class relationship information, the object name relationship information indicating whether or not the name of the object assumed to actually belong to one of the plurality of classes, and the name of the object recognized by the object recognition process agree with each other.

5. The object recognition device according to claim 4, wherein the processor acquires a correction value for correcting the recognition score obtained by the object recognition processing based on the appearance similarity information and the object name relationship information.

6. The object recognition device according to claim 2, wherein the processor acquires size information as the area relationship information corresponding to the two object areas having the connection relationship, the size information being information relating to a magnitude relationship of relative sizes of the objects included in the two object areas.

7. The object recognition device according to claim 6, wherein the processor acquires height relationship information as the class relationship information, the height relationship information being information indicating a relationship between a height of the object assumed to actually belong to one of the plurality of classes, and a height of the object recognized by the object recognition processing.

8. The object recognition device according to claim 7, wherein the processor acquires a correction value for correcting the recognition score obtained by the object recognition processing based on the size information and the height relationship information.

9. An object recognition method comprising:
acquiring an image including a plurality of objects;
acquiring recognition results corresponding to each of the plurality of objects included in the image by performing object recognition processing on the image;
performing processing for specifying whether or not there is a connection relationship of a plurality of object areas corresponding to the plurality of objects based on the recognition results obtained by the object recognition processing;
acquiring an area relationship information that is information related to a relationship of each object areas identified to have the connection relationship;
acquiring a class relationship information which is information indicating a relationship of a plurality of classes set in advance in order to obtain the recognition results by the object recognition processing;
acquiring a plurality of corrected recognition results by performing recognition result correction processing for correcting the recognition results obtained by the object recognition processing based on the area relationship information and the class relationship information; and
acquiring a final recognition result relating to the class to which each of the plurality of objects belongs, by evaluating the recognition results obtained by the object recognition processing using the plurality of the corrected recognition result.

10. A non-transitory computer-readable recording medium recording a program, the program causing a computer to execute:
acquiring an image including a plurality of objects;
acquiring recognition results corresponding to each of the plurality of objects included in the image by performing object recognition processing on the image;
performing processing for specifying whether or not there is a connection relationship of a plurality of object areas corresponding to the plurality of objects based on the recognition results obtained by the object recognition processing;
acquiring an area relationship information that is information related to a relationship of each object areas identified to have the connection relationship;
acquiring a class relationship information which is information indicating a relationship of a plurality of classes set in advance in order to obtain the recognition results by the object recognition processing;
acquiring a plurality of corrected recognition results by performing recognition result correction processing for correcting the recognition results obtained by the object recognition processing based on the area relationship information and the class relationship information; and
acquiring a final recognition result relating to the class to which each of the plurality of objects belongs, by evaluating the recognition results obtained by the object recognition processing using the plurality of the corrected recognition result.
